(19) United States
(12) Patent Application Publication
(10) Pub. No.: US 2023/0343959 A1
(43) Pub. Date: Oct. 26, 2023

(54) NOVEL BORON-MODIFIED HEMP-BASED CARBON AND METHODS OF MAKING SUCH FOR IMPROVED ELECTRICAL DEVICES

(71) Applicant: Son Nguyen, Tulsa, OK (US)

(72) Inventor: Son Nguyen, Tulsa, OK (US)

(21) Appl. No.: 18/137,946

(22) Filed: Apr. 21, 2023

Related U.S. Application Data
(60) Provisional application No. 63/363,381, filed on Apr. 21, 2022.

(51) Int. Cl. H01M 4/587; C01B 32/05; H01M 10/054; H01M 4/133

(52) U.S. Cl. CPC H01M 4/587; C01B 32/05; H01M 10/054; H01M 4/133; C01P 2002/54; C01P 2006/40; C01P 2004/61; H01M 2004/027

(57) ABSTRACT

Novel boron-modified hemp-based carbon and a method for making such comprises pretreating hemp precursors with boron and a catalyst to obtain boron-modified hemp that is carbonized to provide the novel boron-modified hemp-based carbon that in certain embodiments has a porous structure and chemical properties that are suitable for energy storage devices, especially metal-sulfur batteries; for example, the carbon, when used in a lithium-sulfur battery, can restrain polysulfide diffusion.

### CROSS REFERENCE TO RELATED APPLICATIONS

This application claims the benefit of U.S. Provisional Application Ser. No. 63/363,381, filed on Apr. 21, 2022, which is hereby incorporated by reference herein.

### FIELD OF THE INVENTION

The present invention generally relates to the fabrication of batteries, storage devices, and other electrical devices, and components thereof, including a process for boron doping of hemp-based carbon.

### BACKGROUND OF THE INVENTION

In the construction of metal-sulfur batteries and supercapacitors, a number of different types of carbon were unsuccessful in their application to mitigate the shuttling effect that reduces the number of charge and recharge cycles of such devices.

Hemp-based carbon, which may be prepared from raw hemp utilizing a hydrothermal processing and chemical activation, has been used in the construction of some carbon based structures such as supercapacitors using nanosheets. Hemp-based carbon reduces a shuttling effect by localizing polysulfides in its unique porous structure. However, hemp-based carbon used in the past did not eliminate the shuttling effect and improved carbon and methods are needed.

### SUMMARY

Embodiments of the present invention provide a process for fabricating novel boron-modified hemp-based carbon for batteries, and for storage and other electrical devices, including but not limited to supercapacitors, and in particular, a battery and/or supercapacitor having a boron-modified hemp-based carbon/sulfur cathode structure.

In certain embodiments of the boron-modified hemp-based carbon that is made by the processes disclosed herein, the carbon is expected to have a pore distribution that restrains polysulfide diffusion to mitigate some to all of the shuffling effect (e.g., eliminate greater than about 50% to about 99.99% of the shuttling current) between the anode and cathode of metal-sulfur batteries.

In one embodiment, a method of fabricating boron-modified hemp-based carbon comprises pretreating hemp precursors with boron and a catalyst to obtain boron-modified hemp. A carbonization treatment is performed with the boron-modified hemp to obtain boron-modified hemp-based carbon.

In an embodiment, the pretreating of the hemp precursors is performed with a nickel nitrate catalyst.

In an embodiment, the method comprises providing the boron with the nickel nitrate catalyst at a ratio of (a) about 1 part boron to (b) about 0.5 parts to about 3 parts nickel nitrate catalyst (e.g., preferably a ratio of 1:0.5-3 boron/nickel nitrate catalyst) dispersed in an aqueous or non-aqueous solvent.

In an embodiment, the method comprises performing the carbonization treatment using pyrolysis using a vacuum furnace.

In an embodiment, the pyrolysis used for the carbonization comprises subjecting the furnace with the hemp precursors to a vacuum treatment, inserting an inert gas into the furnace; ramping up the temperature of the furnace after inserting the inert gas (e.g., N₂, Ar, He, H₂) and heating the hemp precursors at a temperature from about 500° C. to about 1200° C., optionally under gas quenching pressure from 0 to 5 MPa, for between about 4 hours to about 10 hours.

In an embodiment, the method comprises fabricating hemp precursors by grinding hemp into hemp particles sized from about 0.1 mm to about 10 mm, cleaning the hemp particles with a cleaning agent; and drying the hemp particles.

In an embodiment, the method comprises a cleaning agent that is selected from the group consisting of acetone, ethanol, alcohol, and distilled water.

In an embodiment, the drying of the hemp particles is performed with elevated temperatures from about 40° C. to about 110° C. and/or vacuuming the cleaned hemp particles.

In one embodiment, a metal-sulfur cathode comprises boron-modified hemp-based carbon according to the process described herein.

In one embodiment, a metal-sulfur battery comprises a cathode comprising a boron-modified hemp-based carbon, the cathode configured to store sulfur that reacts with metal ions when the battery is discharging. This embodiment also comprises an anode that comprises a metal, the anode configured to store the metal and release metal ions when the battery is discharging. This embodiment also comprises an electrolyte configured to transport the ions to/from (i.e., to and from) the anode and the cathode. This embodiment also comprises a separator configured to permit the metal ions to flow between the anode and the cathode. The cathode in some embodiments further comprises oxidative active materials.

In one embodiment, the metal-sulfur battery is a lithium-sulfur battery.

In one embodiment, the metal-sulfur battery is a sodium-sulfur battery.

In one embodiment, the metal-sulfur battery is a potassium-sulfur battery.

These and other features will become apparent from the following detailed description of illustrative embodiments thereof, which is to be read in connection with the accompanying drawings.

### BRIEF DESCRIPTION OF THE DRAWINGS

The drawings are of illustrative embodiments. They do not illustrate all embodiments. Other embodiments may be used in addition to or instead. Details that may be apparent or unnecessary may be omitted to save space or for more effective illustration. Some embodiments may be practiced with additional components or steps and/or without all the components or operations that are illustrated. When the same numeral appears in different drawings, it refers to the same or like components or operations.

FIG. 1 is a flowchart illustrating the operations of a fabrication process of boron-modified hemp-based carbon according to an embodiment of the present invention.

FIG. 2 illustrates a battery according to an illustrative embodiment of the present invention.

### DETAILED DESCRIPTION

In the following detailed description, numerous specific details are set forth by way of examples to provide a thorough understanding of the relevant teachings. However, it should be understood that the present teachings may be practiced without such details. In other instances, well-known methods, procedures, components, and/or circuitry have been described at a relatively high level, without detail, to avoid unnecessarily obscuring aspects of the present teachings. The order of operation shown and described in the flowchart(s) are provided for illustrative purposes, and the claimed subject matter is not limited to the order and/or operations shown in the flowchart(s).

According to embodiments of the present invention, the pretreatment of the hemp precursors leads to the carbon having a special pore distribution that restrains polysulfide diffusion to mitigate some to all of the shuffling effect between the anode and cathode of metal-sulfur batteries.

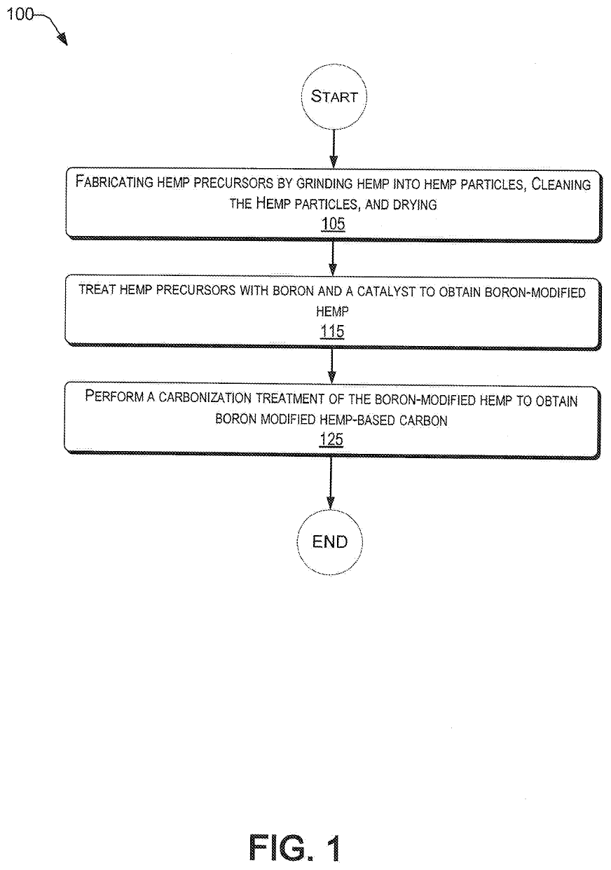

FIG. 1 is a flowchart illustrating the operations of a fabrication process of boron-modified hemp-based carbon according to an embodiment of the present invention.

At operation 105, hemp precursors are prepared by grinding hemp into hemp particles, cleaning the hemp particles, and drying with an elevated temperature (e.g., 40° C.-110° C.), and/or using a vacuum oven.

At operation 115, the hemp precursors are treated with boron and a catalyst to obtain boron-modified product. The catalyst can include, for example, nickel nitrate dispersed in an aqueous or non-aqueous solvent. For example, methanol or ethanol can be used to form an Ni—B emulsion. The dispersion of the catalyst can be conducted by either mechanical and/or ultrasonic stirring, and then dried in an over at a temperature of about 40° C. to about 110° C. A vacuum can be used to assist in the drying. An Ni—B hemp is obtained.

At operation 125, a carbonization treatment is performed on the boron-modified hemp to obtain boron-modified hemp-based carbon. In an embodiment, pyrolysis is conducted through a vacuum furnace. The furnace may be first subjected to a vacuum treatment, and then an inert gas (e.g., argon) may be injected into the furnace before ramping up the temperature. The carbonization treatment is performed at a temperature of about 500° C. to about 1200° C. for a time of about 4 hours to about 10 hours. A higher gas quenching pressure from 0-5 MPa during the pyrolysis process is preferred.

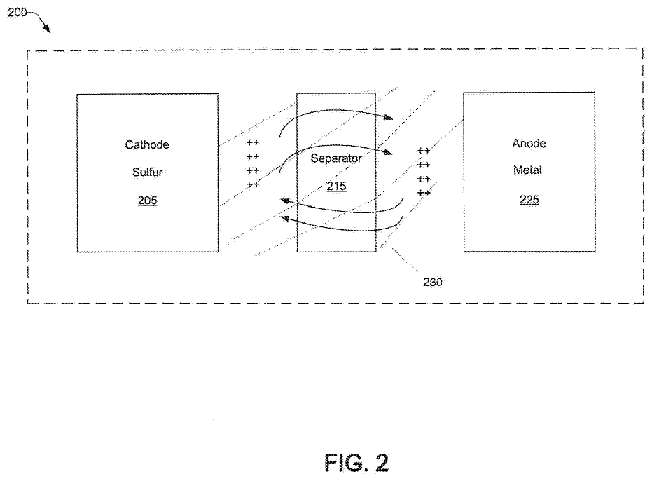

FIG. 2 illustrates a battery according to an illustrative embodiment of the present invention. As shown in FIG. 2, there is an anode 205, a cathode 225 opposite the anode 205, and a separator 215 between them. An electrolyte 230 is represented by the slanted lines in contact with both the anode 205 and the cathode 225. The metal in the anode 205 comprises but is not in any way limited to lithium, sodium, and/or potassium. The cathode 225 comprises sulfur and boron-modified hemp-based carbon of this invention. The battery 200 will comprise current collectors and electrodes, connected to a respective cathode 225 and anode 205. The boron-modified hemp-based carbon is made according to an embodiment described above. The use of the boron-modified hemp-based carbon reduces (and in some embodiments eliminates) the shuttling effect caused by polysulfides interacting with the metal (including but not limited to the lithium, sodium and/or potassium arrangements discussed above).

The descriptions of the various embodiments of a process for fabricating boron-modified hemp-based carbon for batteries, and for storage devices including but not limited to supercapacitors and batteries having a boron-modified hemp-based carbon/sulfur cathode structure, and a battery, supercapacitor and/or a battery component constructed with the boron-modified hemp-based carbon structure according to the present invention, have been presented for purposes of illustration, but are not intended to be exhaustive or to limit the invention to the particular embodiments disclosed. Many modifications and variations will be apparent to those of ordinary skill in the art without departing from the scope and spirit of the invention. The terminology used herein was chosen to explain the principles of the embodiments, the practical application or technical improvement over technologies found in the marketplace, or to enable others of ordinary skill in the art to understand the embodiments disclosed herein.

The components, operations, steps, features, objects, benefits, and advantages that have been discussed herein are merely illustrative. None of them, nor the discussions relating to them, are intended to limit the scope of the invention. While various advantages have been discussed herein, it will be understood that not all embodiments necessarily include all advantages. Unless otherwise stated, all measurements, values, ratings, positions, magnitudes, sizes, and other specifications that are set forth in this specification, including in the claims that follow, are approximate, and not exact. They are intended to have a reasonable range that is consistent with the functions to which they relate and with what is customary in the art to which they pertain.

Numerous other embodiments of the invention are also contemplated. There are also embodiments of the invention in which the components and/or operations are arranged and/or ordered differently than described and shown herein.

It will be understood that the terms and expressions used herein have the ordinary meaning as is accorded to such terms and expressions with respect to their corresponding respective areas of inquiry and study except where specific meanings have otherwise been set forth herein. Relational terms such as first and second and the like may be used solely to distinguish one entity or action from another without necessarily requiring or implying any such actual relationship or order between such entities or actions. The terms “comprises,” “comprising,” or any other variation thereof, are intended to cover a non-exclusive inclusion, such that a process, method, article, or apparatus that comprises a list of elements does not include only those elements but may include other elements not expressly listed or inherent to such process, method, article, or apparatus. An element proceeded by “a” or “an” does not, without further constraints, preclude the existence of additional identical elements in the process, method, article, or apparatus that comprises the element.

Exemplary embodiments of this invention follow.

### Example 1

In certain embodiments of the invention disclosed herein, it is expected that the novel boron-modified hemp-based carbon provided has a pore distribution that restrains polysulfide diffusion to mitigate some to all of the shuffling effect (e.g., eliminate greater than about 50% to about 99.99%) between the anode and cathode of metal-sulfur batteries.

In applications of these embodiments of the boron-modified hemp-based carbon in metal-sulfur batteries or supercapacitors, it is expected that the devices will last about 1.5 to about 10 times longer or more than devices without the boron-modified hemp-based carbon using prior art components.

### Example 2

In certain embodiments of the invention disclosed herein, it is expected that the novel metal-sulfur batteries disclosed herein will contain a boron-modified hemp-based carbon that has a pore distribution that restrains polysulfide diffusion to mitigate some to all of the shuffling effect (e.g., eliminate greater than about 50% to about 99.99%) between the anode and cathode of such metal-sulfur batteries.

In applications of these embodiments of the boron-modified hemp-based carbon in metal-sulfur batteries and supercapacitors, it is expected that the batteries and supercapacitors will last about 1.5 to about 10 times longer or more than batteries and supercapacitors without the boron-modified hemp-based carbon and which are instead using prior art components.

### Example 3

In preferred embodiments of this invention, a method is provided for fabricating boron-modified hemp-based carbon. The method comprises (a) pretreating hemp precursors with boron and a catalyst to obtain boron-modified hemp; and (b) performing a carbonization treatment of the boron-modified hemp to obtain boron-modified hemp-based carbon.

In certain of these preferred embodiments of this invention, the pretreating of the hemp precursors is performed with a nickel nitrate catalyst. In certain of these particular preferred embodiments, the boron with the nickel nitrate catalyst is provided at a ratio of about 1 part boron to about 0.5 parts to about 3 parts nickel nitrate catalyst, dispersed in an aqueous or non-aqueous solvent.

In certain of these preferred embodiments of this invention, the carbonization treatment is performed using pyrolysis through a high pressure vacuum furnace. In certain of these particular preferred methods, the pyrolysis comprises (a) subjecting the furnace with the hemp precursors to a vacuum treatment; (b) inserting an inert gas into the furnace; (c) ramping up a temperature of the furnace after inserting the inert gas; and (d) heating the hemp precursors at a temperature from about 500° C. to about 1200° C. for between about 4 hours to about 10 hours. In certain of these particular preferred methods, the heating of the hemp precursors is performed under a gas quenching pressure from 0-5 MPa.

In certain of these preferred embodiments of this invention, hemp precursors are used that are prepared by a process comprising (a) grinding hemp into hemp particles sized from about 0.1 mm to about 10 mm; (b) cleaning the hemp particles with a cleaning agent; and (c) drying the hemp particles. In certain of these particular preferred methods, the cleaning agent is selected from the group consisting of acetone, ethanol, alcohol, and distilled water. In certain of these particular preferred methods, the drying of the hemp particles is performed with elevated temperatures in the range from about 40° C. to about 110° C. and/or vacuuming the cleaned hemp particles.

In certain of these preferred embodiments of this invention, the resulting boron-modified hemp-based carbon made from these preferred methods has a pore distribution that restrains polysulfide diffusion to mitigate greater than about 50% of the shuffling effect between the anode and cathode of a metal-sulfur battery. In certain of these particular preferred embodiments, the boron-modified hemp-based carbon has a pore distribution that restrains polysulfide diffusion to mitigate greater than about 99.99% of the shuffling effect between the anode and cathode of a metal-sulfur battery.

In certain of these preferred embodiments of this invention, the resulting and novel boron-modified hemp-based carbon made from these preferred methods is used in a cathode, a battery or a supercapacitor.

In certain of these preferred embodiments of this invention, a novel metal-sulfur battery or supercapacitor is provided with the boron-modified hemp-based carbon from these preferred methods.

### Example 4

In certain preferred embodiments of this invention, a metal-sulfur battery or supercapacitor is provided. The metal-sulfur battery or supercapacitor comprises (a) a cathode comprising a boron-modified hemp-based carbon of this invention, the cathode configured to store sulfur that reacts with metal ions when the battery is discharging; (b) an anode comprising a metal, the anode configured to store the metal and release the metal ions from the metal when the battery is discharging; (c) an electrolyte disposed in the cathode and in contact with the anode, the electrolyte configured to transport the metal ions to and from the anode and the cathode; and (d) a separator disposed between the anode and the cathode to permit the electrolyte and the metal ions to flow between the anode and the cathode; and (e) wherein the cathode further comprises oxidative active materials. In certain of these particular preferred embodiments, the metal is a lithium-metal. In certain of these particular preferred embodiments, the electrolyte is configured to transport lithium metal ions to and from the anode and the cathode. In certain of these particular preferred embodiments, the metal is a sodium-metal or a potassium-metal.

### Example 5

In the most preferred embodiments of this invention, a method is provided for fabricating boron-modified hemp-based carbon. The method comprises (a) pretreating hemp precursors with boron and a catalyst to obtain boron-modified hemp; and (b) performing a carbonization treatment of the boron-modified hemp to obtain boron-modified hemp-based carbon. The pretreating of the hemp precursors is performed with a nickel nitrate catalyst and the boron with the nickel nitrate catalyst is provided at a ratio of about 1 part boron to about 0.5 parts to about 3 parts nickel nitrate catalyst, dispersed in an aqueous or non-aqueous solvent. The carbonization treatment is performed using pyrolysis through a high pressure vacuum furnace and pyrolysis process comprises (a) subjecting the furnace with the hemp precursors to a vacuum treatment; (b) inserting an inert gas into the furnace; (c) ramping up a temperature of the furnace after inserting the inert gas; and (d) heating the hemp precursors at a temperature from about 500° C. to about 1200° C. for between about 4 hours to about 10 hours. The heating of the hemp precursors is performed under a gas quenching pressure from 0-5 MPa.

In these most preferred embodiments, hemp precursors are used that are prepared by a process comprising (a) grinding hemp into hemp particles sized from about 0.1 mm to about 10 mm; (b) cleaning the hemp particles with a cleaning agent; and (c) drying the hemp particles. The cleaning agent is selected from the group consisting of acetone, ethanol, alcohol, and distilled water and the drying of the hemp particles is performed with elevated temperatures in the range from about 40° C. to about 110° C. and/or vacuuming the cleaned hemp particles.

In these most preferred embodiments, the resulting boron-modified hemp-based carbon made from these most preferred methods has a pore distribution that restrains polysulfide diffusion to mitigate greater than about 50% to about 99.99% or more of the shuffling effect between the anode and cathode of a metal-sulfur battery. This boron-modified hemp-based carbon can be used in a metal-sulfur battery or a supercapacitor.

### Example 6

In the most preferred embodiments of this invention, a metal-sulfur battery or supercapacitor is provided. The metal-sulfur battery or supercapacitor comprises (a) a cathode comprising a boron-modified hemp-based carbon of this invention, the cathode configured to store sulfur that reacts with metal ions when the battery is discharging; (b) an anode comprising a metal, the anode configured to store the metal and release the metal ions from the metal when the battery is discharging; (c) an electrolyte disposed in the cathode and in contact with the anode, the electrolyte configured to transport the metal ions to and from the anode and the cathode; and (d) a separator disposed between the anode and the cathode to permit the electrolyte and the metal ions to flow between the anode and the cathode; and (e) wherein the cathode further comprises oxidative active materials. The metal is a lithium-metal; the electrolyte is configured to transport lithium metal ions to and from the anode and the cathode; and the metal is a sodium-metal or a potassium-metal.

What is claimed is:

1. A method of fabricating boron-modified hemp-based carbon, the method comprising:
pretreating hemp precursors with boron and a catalyst to obtain boron-modified hemp; and
performing a carbonization treatment of the boron-modified hemp to obtain boron-modified hemp-based carbon.

2. The method according to claim 1, wherein the pretreating of the hemp precursors is performed with a nickel nitrate catalyst.

3. The method according to claim 2, further comprising providing the boron with the nickel nitrate catalyst at a ratio of about 1 part boron to about 0.5 parts to about 3 parts nickel nitrate catalyst, dispersed in an aqueous or non-aqueous solvent.

4. The method according to claim 2, wherein the carbonization treatment is performed using pyrolysis through a high pressure vacuum furnace.

5. The method according to claim 4, wherein the pyrolysis comprises:
subjecting the furnace with the hemp precursors to a vacuum treatment;
inserting an inert gas into the furnace;
ramping up a temperature of the furnace after inserting the inert gas; and
heating the hemp precursors at a temperature from about 500° C. to about 1200° C. for between about 4 hours to about 10 hours.

6. The method according to claim 5, wherein the heating of the hemp precursors is performed under a gas quenching pressure from 0 to 5 MPa.

7. The method according to claim 4, further comprising:
fabricating hemp precursors by grinding hemp into hemp particles sized from about 0.1 mm to about 10 mm;
cleaning the hemp particles with a cleaning agent; and
drying the hemp particles.

8. The method according to claim 7, wherein the cleaning agent is selected from the group consisting of acetone, ethanol, alcohol, and distilled water.

9. The method according to claim 7, wherein the drying of the hemp particles is performed with elevated temperatures in the range from about 40° C. to about 110° C. and/or vacuuming the cleaned hemp particles.

10. A boron-modified hemp-based carbon made from the method of claim 1.

11. A boron-modified hemp-based carbon made from the method of claim 9.

12. A boron-modified hemp-based carbon with a pore distribution that restrains polysulfide diffusion to mitigate greater than about 50% of the shuffling effect between the anode and cathode of a metal-sulfur battery.

13. A boron-modified hemp-based carbon with a pore distribution that restrains polysulfide diffusion to mitigate greater than about 99.99% of the shuffling effect between the anode and cathode of a metal-sulfur battery.

14. A carbon component for a cathode, battery or supercapacitor made by the method of claim 1.

15. A carbon component for a cathode, battery or supercapacitor made by the method of claim 9.

16. A cathode, metal-sulfur battery or supercapacitor comprising the carbon made by the method of claim 1.

17. A cathode, metal-sulfur battery or supercapacitor comprising the carbon made by the method of claim 9.

18. A metal-sulfur battery, the metal-sulfur battery comprising:
a cathode comprising a boron-modified hemp-based carbon, the cathode configured to store sulfur that reacts with metal ions when the battery is discharging;
an anode comprising a metal, the anode configured to store the metal and release the metal ions from the metal when the battery is discharging;
an electrolyte disposed in the cathode and in contact with the anode, the electrolyte configured to transport the metal ions to and from the anode and the cathode; and
a separator disposed between the anode and the cathode to permit the electrolyte and the metal ions to flow between the anode and the cathode; and
wherein the cathode further comprises oxidative active materials. metal.

19. The metal-sulfur battery according to claim 18, wherein the metal is a lithium-metal.

20. The metal-sulfur battery according to claim 19, wherein the electrolyte is configured to transport lithium metal ions to and from the anode and the cathode. metal. metal.

21. The metal-sulfur battery according to claim 18, wherein the metal is a sodium-metal.

22. The metal-sulfur battery according to claim 18, wherein the metal is a potassium-metal.
